(19) United States
(12) Patent Application Publication
(10) Pub. No.: US 2015/0097937 A1
(43) Pub. Date: Apr. 9, 2015

(54) SINGLE-CAMERA MOTION CAPTURE SYSTEM

(71) Applicant: Ali Kord, Los Angeles, CA (US)

(72) Inventor: Ali Kord, Los Angeles, CA (US)

(21) Appl. No.: 14/509,775

(22) Filed: Oct. 8, 2014

Related U.S. Application Data
(60) Provisional application No. 61/888,117, filed on Oct. 8, 2013.

(51) Int. Cl. H04N 5/262; G06T 3/40; G06K 9/00; G06T 7/00

(52) U.S. Cl. CPC H04N 5/2628; G06T 7/0018; G06T 3/40; G06K 9/00342
USPC 348/77

(57) ABSTRACT

Images of a moving motion capture subject are captured by exactly one digital camera. Links and joints for a biomechanical skeleton are overlaid on a silhouette for each captured image. A true length for each link and an accurate position for each joint in the biomechanical skeleton may be determined by comparing true dimensions of an image calibration tool to dimensions of the tool measured in images captured by the camera from a single, stationary camera position. The motion capture subject may perform a sequence of calibration motions to allow joint locations in the biomechanical skeleton to be positioned accurately over corresponding skeletal joints in the motion capture subject. Accurate link lengths for the biomechanical skeleton may be determined from images of the image calibration tool. An apparatus embodiment includes an image calibration tool. A method embodiment includes steps for calibrating images with an image calibration tool.

### FIELD OF THE INVENTION

Embodiments of the invention are generally related creation of an articulated, movable mathematical model of a person from position, size, and angle information extracted from digital camera images.

### BACKGROUND

A motion capture system records the movements of a motion capture subject in a sequence of digital images, converting the recorded images to a mathematical model that may be manipulated in a computer system. The mathematical model may represent a biomechanical skeleton having rigid links connected to one another by rotatable joints. A computer graphics system may map images of a character in a motion picture or video game onto the links and joints of the biomechanical skeleton to cause the character's movements to emulate the motion capture subject's movements. Or, the biomechanical skeleton may be used to compare the positions and motions of the motion capture subject to data related to preferred positions or motions, for example for sports training or medical diagnosis.

A biomechanical skeleton may be articulated differently than a human skeleton and may have a different range of motion for a joint between connected links than a corresponding joint in a human skeleton. A complicated biological structure such as a human hand or foot may be represented in a biomechanical skeleton with a simpler combination of links and joints. Examples of simplified biomechanical skeletons include a foot modeled without individual toes, a model of a spine represented with fewer joints than a human spinal column, a limb represented with a smaller range of motion than a real human limb, and so on.

Some motion capture systems use triangulation to determine limb and joint positions for a motion capture subject from digital camera images collected from more than one camera. For motion capture by triangulation, multiple cameras with different viewing positions are directed at a motion capture subject, each captured image representing a view of the subject from a different angle. For stationary subjects, images from different viewing angles may be collected by repositioning a single camera to a new viewing angle for each image. A moving subject is preferably recorded simultaneously by each of several cameras as the subject moves about a predefined activity area such as a stage, set, area for playing a game, and so on. Reference locations in images captured by each camera are then compared with known camera positions, camera lens parameters, positions and sizes of reference markers, and other factors to convert distances and angles measured from images to true distances and true angles compensated for distortions introduced by lens systems, for example perspective distortion such as convergence of parallel lines. Biomechanical skeleton parameters such as limb length, limb angle, joint position, and subject location in the activity area may be assigned values related to true distances and true angles determined from recorded images.

Multiple-camera motion capture systems may use a complex gantry system for holding cameras and lights in accurately determined spatial relationships to one another and to a scene being recorded. Motion capture systems using multiple cameras are very expensive to set up, difficult to calibrate, complicated to operate, and may require sophisticated post-acquisition data analysis to process images from different cameras, each having a different view of a scene and motion capture subject.

Some motion capture systems enhance modeling accuracy by placing motion capture targets on a motion capture subject. Motion capture targets may also be placed on props, tools, or sporting equipment used by a motion capture subject. Motion capture targets may be placed on a subject to enable accurate determination of positions and angles from recorded images. The capture targets, for example reflective tape, reflective hemispheres, high-contrast paint dots, and the like, may require intense illumination, cameras sensitive to infrared light, infrared light sources, or other specialized photography equipment to enable identification and accurate positioning of capture targets in recorded images. Capture targets may interfere with the preferred appearance or responses of the motion capture subject. Capture targets may be blocked from the field of view of some cameras as a motion capture subject moves around a room or set, possibly impairing motion capture accuracy. Accurate time synchronization of images from different cameras may be required to produce accurate motion capture results. Differences in lighting, shadows, and obstructions in the field of view for each camera may interfere with motion capture analysis of captured images.

Other motion capture systems require a person to wear inertial measurement sensors that record translation and possibly rotation around one or more spatial axes while the person moves about. The inertial measurement sensors may be heavy or bulky enough to affect the motions being captured. The size and weight of an inertial measurement sensor on a person's leg, arm, or hand may distract the person or change a speed of a motion, a response time, or an extent of angular motion. For example, an inertial motion sensor may reduce the velocity or direction of a golf swing or may interfere with a gymnast's movements during tumbling exercises.

Some motion capture systems require a person to wear an articulated mechanical frame for measuring angles between parts of a limb, spine, torso, or other parts of a person's body. The articulated frame may be susceptible to damage during vigorous activity and may interfere with a person's speed of motion or impair a full range of motion, and may have a visual appearance that detracts from a preferred aesthetic effect in a camera image.

### SUMMARY

An example of an apparatus embodiment includes a digital camera, a central processing unit in data communication with the digital camera, a memory in data communication with the central processing unit, and an image calibration tool. The image calibration tool includes a first calibration marker, a second calibration marker, a third calibration marker, and a fourth calibration marker, a first strut connected between the first calibration marker and the second calibration marker, a second strut connected between the first calibration marker and the third calibration marker with a first straight line segment between the first calibration marker and the second calibration marker perpendicular to a second straight line segment between the first calibration marker and the third calibration marker, and a third strut connected between the first calibration marker and the fourth calibration marker with a third line segment between the first calibration marker and the fourth calibration marker perpendicular to the first line segment and to the second line segment. The central processing unit is adapted to scale an image recorded by the digital camera in the memory by comparing a distance measured between the first and second calibration markers on the image calibration tool to a corresponding distance between the first and second calibration markers in the image.

The example of an apparatus embodiment of the invention further includes a camera and a computer implemented in hardware, wherein the camera is in data communication with the computer and the computer is adapted to receive an image from the camera, convert the image to a silhouette, and extract parameters for an actor file from the image.

An example of a method embodiment includes the capturing a sequence of digital images of a motion capture subject, each of the sequence of digital images including an image of an image calibration tool, determining a separate scale factor for each of three mutually orthogonal spatial directions by comparing a separation distance between two calibration markers on the image calibration tool to a corresponding distance between the same two calibration markers a digital image, and overlaying a biomechanical skeleton over each of the sequence of digital images, with a biomechanical reference location superimposed over a movable joint of the motion capture subject and at least one link rotatably coupled to the biomechanical reference location. A length of the link in each image corresponds to a projected length. A true length of each link is determined by adjusting the projected length by the scale factors for each of three mutually orthogonal spatial directions. A joint in the biomechanical skeleton is positioned at the biomechanical reference location and a link having a true length is coupled to the joint.

### BRIEF DESCRIPTION OF THE DRAWINGS

FIG. 1 shows a pictorial view of an example of an apparatus for creating accurately calibrated motion capture images from a single stationary digital camera in data communication with a portable computer.

FIG. 2 is a pictorial view toward the front of a person acting as a motion capture subject, with the subject standing in an example of a scale frame, the scale frame positioned relative to a camera as in the example of FIG. 1, the subject's right hand at the left side of the figure, and an example of a biomechanical skeleton model overlaid on the motion capture subject showing examples of correspondence between links and joints in the biomechanical skeleton with the person's joints, limbs, head, neck, and torso.

FIG. 3 is an example of a silhouette determined from a digital image of the motion capture subject of FIG. 2.

FIG. 4 is a pictorial view of the motion capture subject of FIG. 2, with the subject facing the left side of the scale frame and her right side toward the front of the scale frame.

FIG. 5 shows an example of a motion capture subject with the subject's right leg inside an example of an alternative embodiment of an image calibration tool, another alternative example of an image calibration tool attached to a cap on the subject's head, and yet another example of an image calibration tool worn on the subject's left leg.

FIG. 6 shows a pictorial view of an alternative embodiment of an image calibration tool and an example of a portable computing device having an integrated digital camera.

FIG. 7 shows an example of an alternative example of an image calibration tool having three struts aligned along three mutually perpendicular spatial axes.

FIG. 8 shows another example of an image calibration tool with three struts aligned along three mutually perpendicular spatial axes, calibration markers of different shapes, and axis identification markings.

FIG. 9 shows a pictorial view of an example of an image calibration tool having solid faces, calibration markers at each corner, and at least three edges aligned with each of the three mutually perpendicular spatial axes.

FIG. 10 is a block diagram of an example of a portable computing device having an integrated digital camera and an optional wireless network communications interface.

### DESCRIPTION

A single digital camera records images of a motion capture subject. The images are analyzed to assign values to parameters for a biomechanical skeleton capable of accurately emulating the motion capture subject's movements and body positions. Image scale information for creating the biomechanical skeleton may be determined along each of the three mutually perpendicular spatial axes by comparing known dimensions for an image calibration tool with corresponding dimensions of the tool's image recorded with images of the subject. After image scale has been determined for all three spatial axes in recorded images, the true length and true position of each link and joint in the biomechanical skeleton may be determined accurately from recorded images so that motions and positions of the motion capture subject may be accurately reproduced by the biomechanical skeleton.

In contrast to some previously known motion captures systems, the single camera in an embodiment may remain entirely stationary in a fixed position for capturing images used for determining accurate positions, angles, and distances along all three mutually perpendicular spatial directions. Captured images may quickly and easily be recalibrated should a camera be located to a new viewing location, for example to record a motion capture subject from a new viewing angle for artistic purposes.

Some embodiments include an image calibration tool having accurately known dimensions, a digital camera, and a computer including a central processing unit implemented in hardware to analyze images collected by the camera. By comparing known sizes and positions of components on the image scale tool to sizes and positions of the same components measured in captured images, true dimensions, true angles, and true positions of objects in captured images may be determined accurately from the images. Examples of parameters which may be determined accurately from calibrated images of a motion capture subject include, but are not limited to, limb length, joint position, limb and joint positions with respect to a position reference, limb angles, and distances traversed by the motion capture subject. The image calibration tool enables accurate determination of angles, positions, and lengths in captured images without the use of multiple cameras or multiple camera positions for a single camera.

A mathematical model in accord with an embodiment may be referred to as an actor file. An actor file represents a motion capture subject, for example a person engaged in a sports activity or an actor in a video game or motion picture, as an articulated biomechanical skeleton comprising rigid links joined to one another at biomechanical reference locations. A biomechanical reference location may also be referred to as a biomechanical joint centroid or more simply as a joint. Some biomechanical reference locations represent the position of a joint in a human skeleton, for example the position of a wrist joint, knee joint, neck joint, or hip joint. Other biomechanical reference locations represent a reference position for measuring a linear dimension such as a length, width, or thickness of part of a human body, for example a length of an upper arm or a separation distance between two reference points on a spine. A biomechanical reference location may optionally represent a compound structure comprising more than one joint or more than one link. For example, a single biomechanical reference location may be assigned to represent a complete human hand.

Parameters to be supplied to an actor file are collected by recording a sequence of images from a moving person who performs a sequence of motions for each part of the person's body to be captured in the actor file. A sequence of motions for determining limb lengths, limb angles, and other parameters preferably includes motions which are isolated to one part of the body at a time. Following a sequence of isolated motions improves model accuracy and reduces cumulative error in the positions and angles of limbs and other body parts represented in the model. Each recorded image to be analyzed may optionally be converted to a silhouette representing the edges of the motion capture subject's limbs, torso, head, and other parts of the subject's body. Biomechanical reference locations may be placed on each image at the ends of extremities, for example the top of a person's head or the bottom of the person's heel, at the centroid of each area determined to represent a skeletal joint on the motion capture subject, on a position selected to represent a complex structure such as a hand, or at any location on the biomechanical skeleton that may be used to represent the position of the person's body with respect to some external position reference, such as the origin of a coordinate system or the position of another object in the field of view of the camera. Embodiments may optionally be adapted to capture images and extract parameters for use in commercially available biomechanical models.

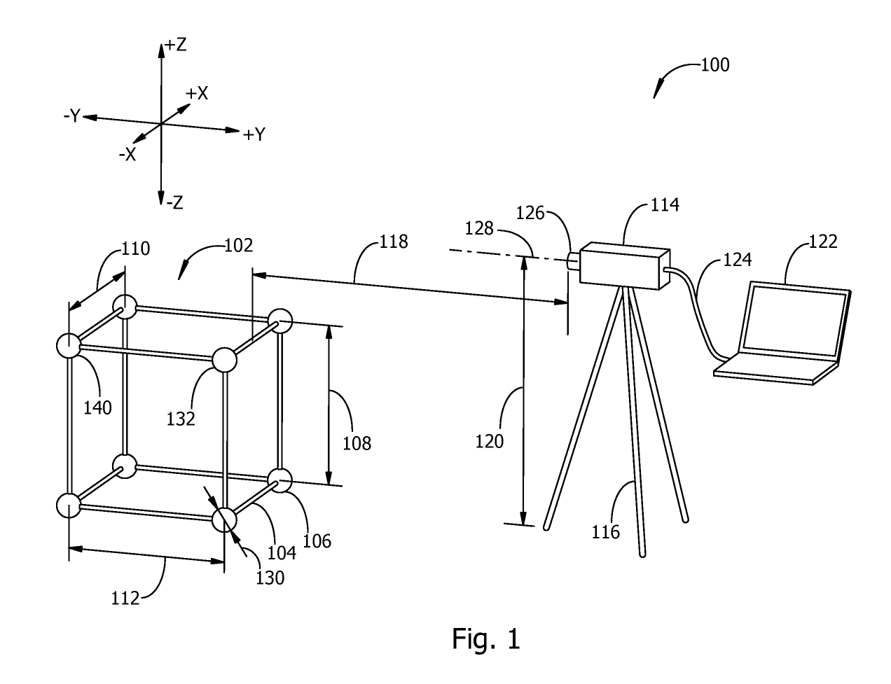

Examples of apparatus in accord with an embodiment are shown in the figures. Turning to FIG. 1, an example of an apparatus embodiment 100 includes a camera 114 having a lens 126 with an optical axis 128 positioned at a height 120 above a horizontal reference surface parallel to the XY plane and tangent to the bottom side of an example of an image calibration tool 102. In the example of FIG. 1, the image calibration tool 102 is constructed as an open frame and may be referred to as a scale frame 102. The camera may optionally be mounted on an adjustable-height tripod 116 or another stable camera support. The camera lens 126 is separated from a front side of the scale frame 102 by a separation distance 118. The optical axis in the example of FIG. 1 is horizontal and parallel to the Y axis. The Z axis in the example of FIG. 1 is vertical and perpendicular to the optical axis 128 of the camera lens. The X axis is perpendicular to the Y and Z axes. The X, Y, and Z axes represent three mutually perpendicular spatial axes used for determining distances, directions, and angles for the motion capture subject and for captured images.

In the example of FIG. 1, a computer 122 receives images recorded by the camera 114 over a data communications connection 124. The computer includes volatile and nonvolatile memory, a central processing unit (CPU) implemented in hardware, at least one data input device such as a keyboard, mouse, or touch input system, and an image display, for example a liquid crystal display, a plasma display, or a light-emitting diode display. Examples of a data communication connection between the computer 122 and camera 114 include, but are not limited to, a wired connection, a wireless connection, a computer network such as a local area network, or the Internet. Alternatively, the computer 122 may receive images from the camera 114 that the camera has stored on nonvolatile computer-readable media such as an optical disk, a magnetic disk, magnetic tape, integrated circuit memory devices in a memory stick, or the like.

The image calibration tool 102 optionally includes at least two calibration markers 106 connected by at least two struts 104. In the example of FIG. 1, each of the calibration markers may take the form of a sphere or ball, although other shapes for calibration markers may be used in other embodiments. Known dimensions, shapes, and positions of the calibration markers with respect to one another are used to create calibrated digital images of the image calibration tool. In a calibrated digital image, distances, positions, and angles measured from the image may be converted to true distances, true positions with respect to a reference location, and true angles.

Continuing with FIG. 1, each strut 104 is preferably perpendicular to other struts attached in common to one of the calibration markers 106. In the example of FIG. 1, a height dimension 108 measured in the direction of the Z axis, a width dimension 110 measured in the direction of the X axis, and a depth dimension 112 measured in the direction of the Y axis for the scale frame 102 are all equal to one another and the eight calibration markers 106 are positioned at the corners of a cube. In alternative embodiments of the scale frame 102, the length, width, and depth dimensions representing separation distances of calibration markers may differ from one another. Calibration markers 106 on different spatial axes may optionally be assigned different colors or may be marked with surface indicia such as text, numbers, or bar codes to enable post-processing software to automatically identify the directions of the x-, y-, and z-axes in a camera image and possibly to automatically remove an image of the scale frame from a captured image.

The calibration markers 106 at each corner of the scale frame may all have a same diameter 130 or may alternatively have different diameters. The diameter 106 may be selected to raise the bottom side of the scale frame sufficiently to permit a person's foot to slide under a strut 104, thereby permitting the person to position their legs and torso as close as possible to a plane tangent to the calibration markers on the front side of the scale frame, where the front side refers to the side facing the camera lens 126 and perpendicular to the optical axis 128.

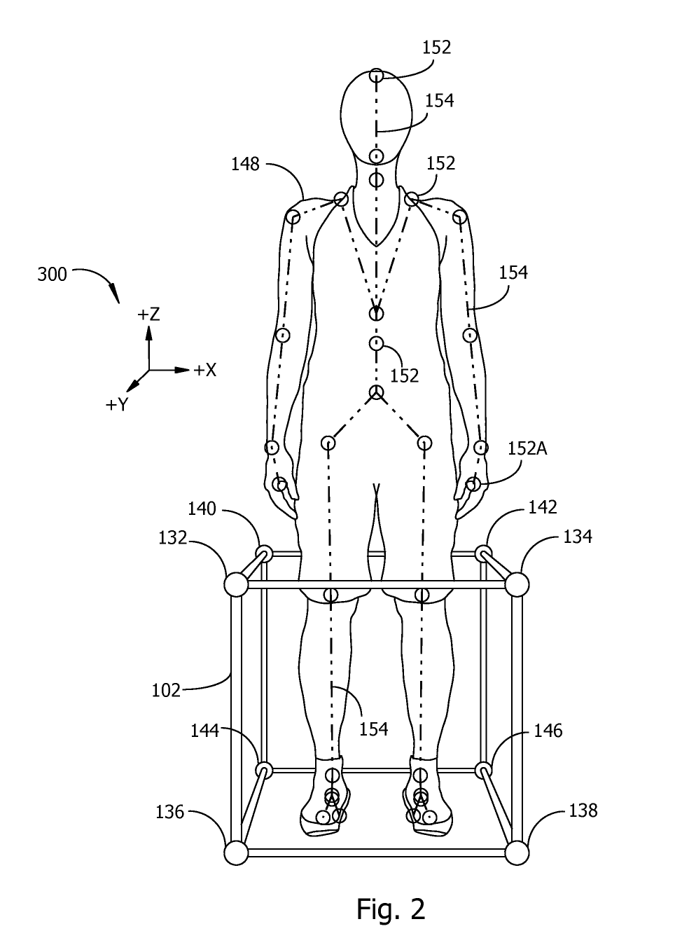

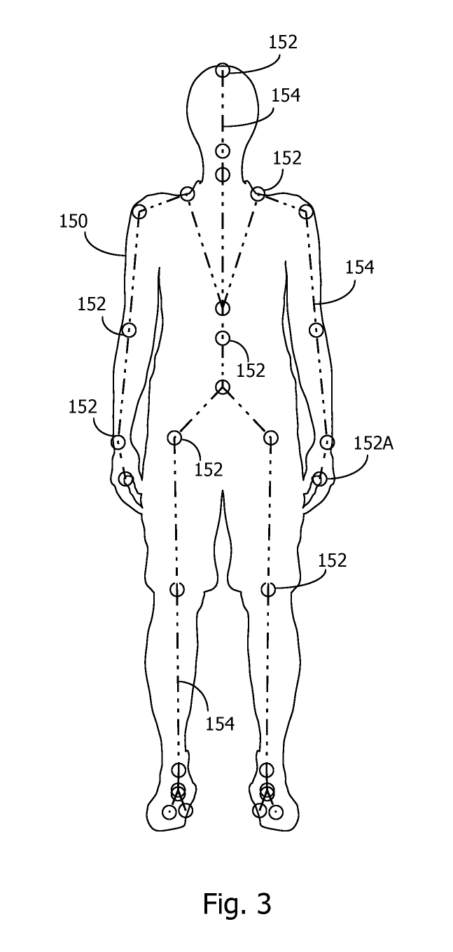

The image calibration tool 102 in the examples of FIGS. 1-2 comprises 12 struts and eight calibration markers 106, including an upper right front ball 132, an upper left front ball 134, a lower right front ball 136, and a lower left front ball 138, where left and right have been labeled with respect a viewing direction along the optical axis 128 toward the image calibration tool 102. Continuing on the back side of the image calibration 102, an upper right back ball 140, an upper left back ball 142, a lower right back ball 144, and a lower left back ball 146 are joined to one another and to the front balls by struts. The known lengths of each strut and the known diameter of each ball in the image calibration tool may be compared to their dimensions in a camera image of the image calibration tool to determine dimensions, angles, and positions for other objects in the image, for example a person standing inside the scale frame as suggested in FIGS. 2-3. For a camera lens 126 of known focal length, the dimensions and angles of the image calibration tool 102 measured from an image recorded by the camera may be used to determine the separation distance 118 between the camera lens and the scale frame.

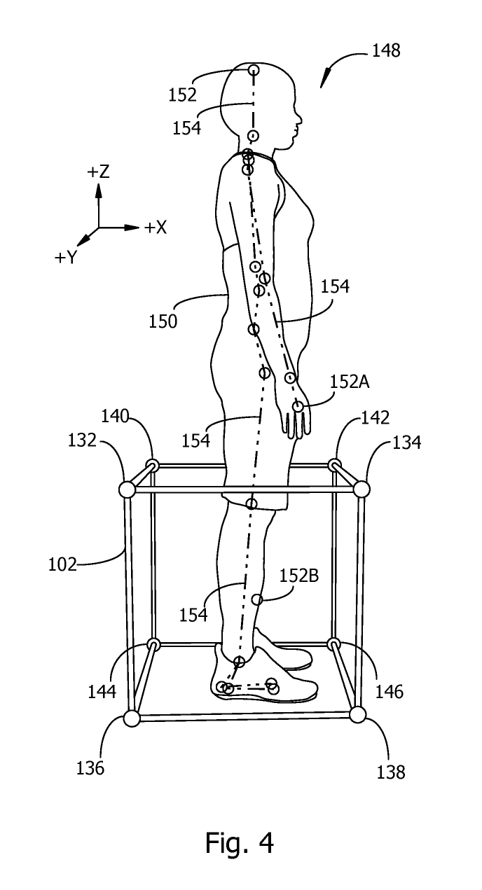

A digital image captured by the digital camera 114 may be processed by a CPU included in some embodiments to extract parameters for an actor file. FIGS. 2-5 show different views of an example of a biomechanical skeleton 154 superimposed over an image recorded by the camera 114 of a motion capture subject 148 standing in an image calibration tool 102. The motion capture subject preferably wears close-fitting clothing to improve the accuracy of positions determined for limb lengths, joint locations, and other parameters extracted from recorded images. An image of a motion capture subject 148 may optionally be processed by the computer (ref. FIG. 1) to form a silhouette 150 corresponding to an outline of the person 148 from the camera's viewing direction. An example of a silhouette is shown in FIG. 3. As the motion capture subject moves, the camera collects images, for example a sequence of video images recorded at 30 frames per second or a sequence of still images recorded at selected positions of the subject 148. Each image is converted to a silhouette by the computer. Individual silhouette images are compared to one another by the computer to assign a location for each biomechanical reference location 152 on the biomechanical skeleton 154. By measuring the positions of biomechanical reference locations in images of the subject and compensating the measured values with scaling information derived from images of the image calibration tool, the spatial coordinates may be determined for each biomechanical reference location on the biomechanical skeleton. A separation distance between adjacent biomechanical reference locations 152 may define the length of a link in the biomechanical skeleton. A biomechanical reference location 152A may represent a complex combination of links and joints, for example a hand. A biomechanical reference location 152B, an example of which appears in FIG. 4, may optionally be assigned to represent a coordinate origin, a convenient reference representative of a position of the model in the actor file, a position of an object related to the subject 148, or other locations convenient in forming or using an actor file.

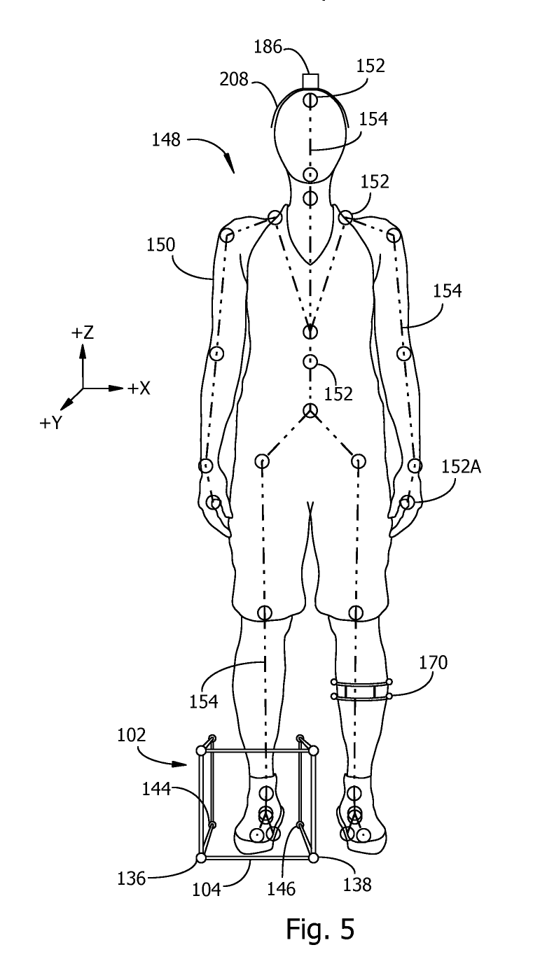

In the example of FIGS. 2 and 4, the motion capture subject 148 stands inside the image calibration tool 102 with hips and shoulders arranged parallel to a front plane defined by any three of the calibration markers (132, 134, 136, 138) on the front side of the frame. Alternative embodiments include different sizes and shapes of image calibration tools, each of the alternative embodiments including at least two calibration markers and at least two interconnecting struts to provide image scaling information for at least two mutually orthogonal spatial axes. One of the alternative image calibration tools shown in the example of FIG. 5 is a scale frame 102 resting on the floor and sized to fit around one foot and the lower portion of one of the motion capture subject's legs. The scale frame 102 in the example of FIG. 4 optionally omits a rear strut to make the tool easier to step into.

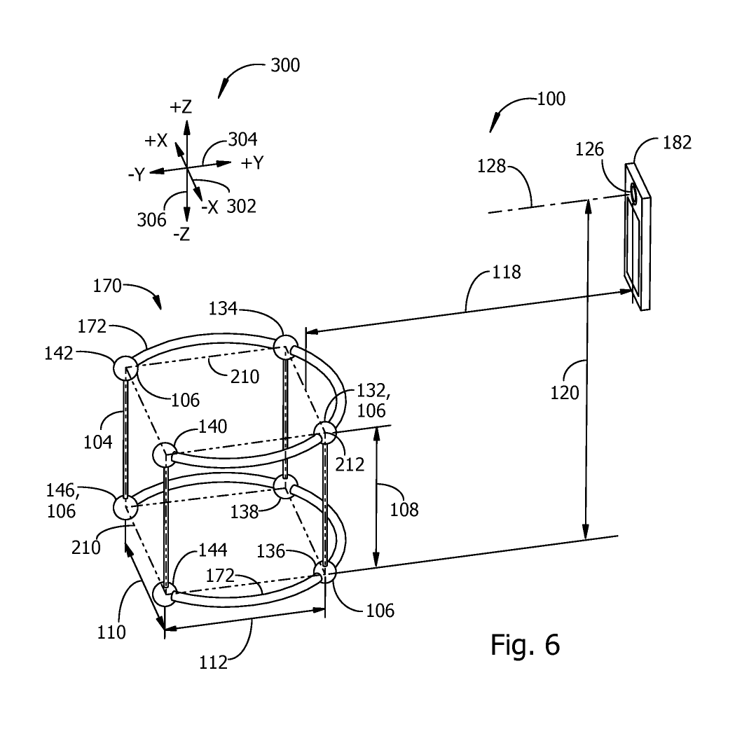

An image calibration tool may optionally be arranged to be worn by the motion capture subject rather than being placed on the floor as in the previous examples. Other examples of an image calibration tool 102 include a tool 170 with curved struts, shown in more detail in the example of FIG. 6. The calibration markers are preferably arranged to fall on lines which are parallel to the three mutually perpendicular spatial axes 300, for example X-axis 302, Y-axis 304, and Z-axis 306, and are further positioned at the corners of a virtual, ideal cube aligned with the three spatial axes, although image calibration tools may have fewer calibration markers and fewer struts as previously explained. An example of calibration markers 106 placed at the vertices 212 of an ideal, virtual cube 210 defining the directions of the X, Y, and Z axes appears in FIG. 6 with the edges of the cube marked by phantom lines. Alternatively, the calibration markers may be positioned at the corners of a virtual, ideal rectangular solid with mutually perpendicular adjacent faces. In some embodiments, calibration markers are positioned at an intermediate location along the length of a strut rather than at an end of a strut. When the positions of the calibration markers are known accurately with respect to one another, the struts 172 need not be straight and may instead be curved in any convenient manner as suggested in the example of FIG. 6.

In the example of FIG. 6, a front plane for measurement of a separation distance 118 to a camera lens 126 may be defined by any selected three of calibration markers 132, 134, 136, and 138. A rear plane on the image calibration tool may be defined by any selected three of calibration markers 140, 142, 144, and 146, with the front and rear planes parallel to one another and perpendicular to an optical axis 128 of a camera lens 126 during image capture for calibration of images used to extract parameters for a biomechanical skeleton. Mutually perpendicular image reference planes XY, XZ, and YZ can similarly be defined by suitable selection of triplets of calibration markers 106, and foreshortening of distances along the X-, Y-, and Z-axes in recorded images may be calculated precisely from corresponding foreshortening of image calibration tool dimensions in captured images. A height dimension 108, width dimension 110, and depth dimension 112 for the example of an image calibration tool of FIG. 6 are defined the same way with respect to the camera lens as for the example of FIG. 1. Some embodiments of an image calibration tool are configured to calibrate dimensions, positions, and angles for only one spatial plane, for example the XZ plane from the example of FIG. 1, by reducing the number of calibration markers and interconnecting struts compared to the embodiment of FIG. 1.

The example of an image calibration tool 170 in FIG. 6 may alternatively be large enough to surround both legs of a motion capture subject as suggested in FIG. 1, or only one leg as shown in the example of FIG. 5. Alternatively, the image calibration tool 170 may be sized for a comfortable fit around a subject's arm or leg as suggested in FIG. 5. Some of the curved struts 172 may optionally be made from a flexible, resilient material to make it easier to place the image calibration tool 170 around an arm or leg.

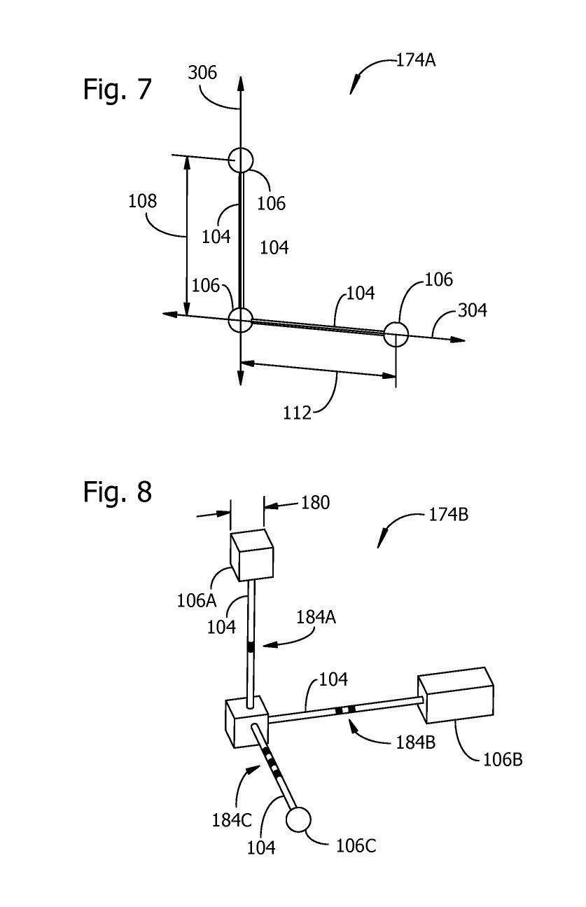

An image calibration tool may include a minimum number of calibration markers and interconnecting struts required to define at least two mutually orthogonal spatial axes 300. In the example of an image calibration tool 174A of FIG. 7, two mutually orthogonal spatial axes (304, 306) are represented by two struts 104 connecting three calibration markers 104, with a height dimension 108 and a depth dimension 112 defined as in earlier examples. All three calibration markers may optionally have approximately spherical shapes as suggested in the example of FIG. 7, or each calibration marker may alternatively be provided with a unique shape to facilitate identification of spatial directions in captured images. The example of an image calibration tool 174B in FIG. 8 uses calibration markers of different shapes 106A, 106B, and 106C to distinguish three mutually perpendicular spatial axes. Image scaling information may optionally be determined from a known linear dimension 180 for a calibration marker 106. Axis labels 184A, 184B, 184C may also be used to identify spatial directions in captured calibration images. Axis labels may optionally be placed along the struts in accurately known positions and may alternatively serve to confirm scaling information determined from calibration markers, or may replace the calibration markers entirely. Axis labels suitable for use with an embodiment include, but are not limited to, computer-readable text, a bar code, a matrix bar code, a unique banding pattern or other indicia on each axis, and color coding, any of which may optionally be recognizable to commercially available image capture software.

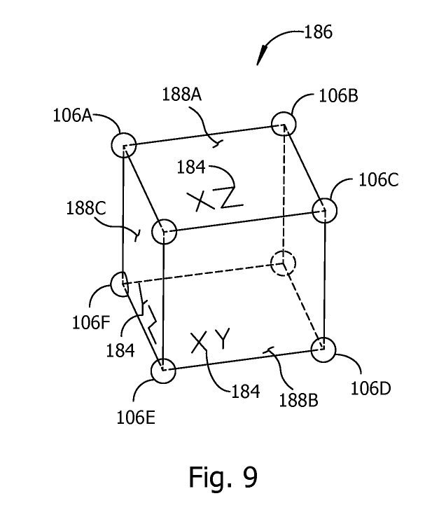

The image calibration tool of the previous examples may be implemented as an open frame or may alternatively be implemented as an n-sided polygon with solid faces having known dimensions for vertex positions and edge lengths. In the example of FIG. 9, an image calibration tool 186 is configured as a cube with calibration markers 106 at each corner of at least two adjacent solid faces 188, for example any selected two of adjacent faces 188A, 188B, and 188C. Printed indicia 184 may optionally be applied to at least one solid face 184 to identify spatial directions in captured images. The image calibration tool 186 in the example of FIG. 9 may optionally be made from an optically transparent material, or may alternately be made with opaque faces 184. The image calibration tool 186 may optionally be made with a size and weight that is convenient for a motion capture subject to wear, as suggested in FIG. 5 where the image calibration tool 186 is attached to a cap or headband 208. An image calibration tool positioned at the top of the subject's head will seldom be obscured as the subject moves his or her limbs or torso or moves about in a performance space.

In the example of FIG. 1, the digital camera 114 and computer 122 are provided as separated devices. In alternative embodiments, the camera and computer may be combined into a single device, for example the portable computer 182 with an integrated camera in FIG. 6. Examples of a portable computer with an integrated camera suitable for use with an embodiment include, but are not limited to, a laptop computer, a tablet computer, a personal digital assistant, and a smart phone having cellular telephone combined with a CPU, data and program memory, and a touch input system.

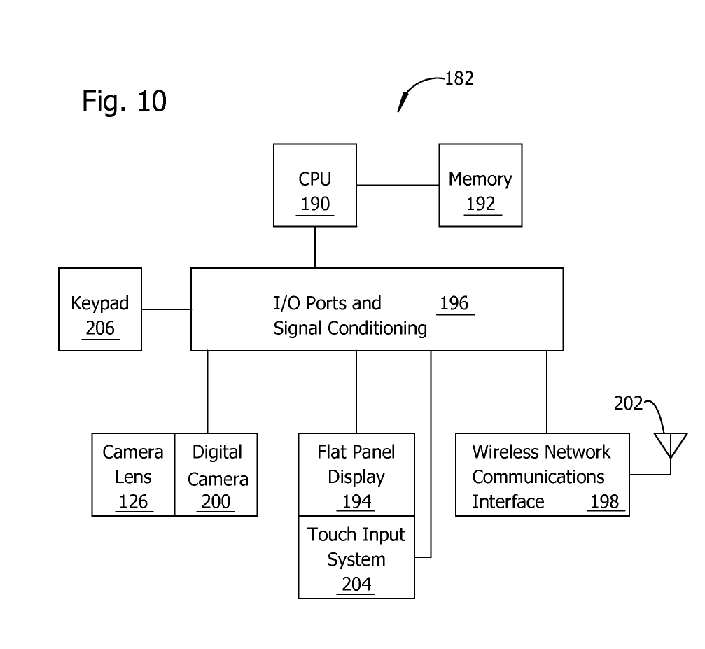

An example of a portable computer 182 is shown as a block diagram in FIG. 10. The portable computer 182 is a hardware device including a CPU 190 connected for data communication with a memory 192 and input/output (I/O) ports 196. An optional keypad 206, a digital camera 200, a flat panel display 194, and an optional wireless network communications interface 198 communicate with the CPU 190 through intervening I/O ports and signal conditioning 196. A touch input system 204 may be used for device control and data entry in addition to, or alternatively instead of, the keypad 206. Image capture and calibration using an image calibration tool may be performed in the portable computer 182 and the parameters of a calibrated biomechanical skeleton determined with the portable computer 182. Alternately, the portable computer may record images and transmit images, parameters related to an image calibration tool, parameters related to the digital camera and camera lens, and other information to another computer system for creation of a calibrated biomechanical skeleton.

An example of a method in accord with an embodiment includes the steps of capturing a sequence of digital images of a motion capture subject, each of the sequence of digital images including an image of an image calibration tool, determining a separate scale factor for each of three mutually orthogonal spatial directions by comparing a separation distance between two calibration markers on the image calibration tool to a corresponding distance between the same two calibration markers in each of said sequence of digital images, and overlaying a biomechanical skeleton over each of the sequence of digital images with a biomechanical reference location superimposed over a movable joint of the motion capture subject and at least one link rotatably coupled to the biomechanical reference location. A length of the link in each image corresponds to a projected length. A true length of each link is determined by adjusting the projected length by the scale factors for each of three mutually orthogonal spatial directions. A joint in the biomechanical skeleton is positioned at the biomechanical reference location and coupling a link having a true length to the joint.

The method embodiment may optionally include any one or more of the following steps:

converting each of the sequence of digital images to a corresponding silhouette, then overlaying the biomechanical skeleton over each silhouette;

recording a front view image of the motion capture subject, recording a side view image of the motion capture subject, and determining an accurate spatial location for the biomechanical reference location from a comparison of a projected distance in the front view image with a corresponding projected distance in the side view image;

rotating a part of the motion capture subject's body about an axis parallel to an optical axis of the camera lens;

positioning the biomechanical reference location at a center of rotation for the rotated part of the motion capture subject's body and positioning a joint in the biomechanical skeleton at the biomechanical reference location;

positioning the image calibration tool in contact with the motion capture subject; and

positioning the motion capture subject with a foot inside the image calibration tool.

Another example of an embodiment may include any one or more of the following steps in a method for producing calibrated images with an image calibration tool. For the following example, spatial directions are defined with respect to the orientation of the x-, y-, and z-axes as shown in FIG. 1, the x-y plane is horizontal and parallel to the surface upon which the motion capture subject stands upright, and the optical axis of the camera lens is parallel to the y-axis:

positioning the camera 114 along the y-axis at a distance 118 selected to fit the motion capture subject 148 into the camera's field of view;

positioning the camera 114 at a height 120 of about half the height of the subject 148;

viewing a recorded video image output from the camera 114 on the image display for the computer 122;

positioning the motion capture subject 148 in the center of the camera's field of view, facing the camera 114 in a relaxed posture and close enough to the camera to achieve desired image resolution, also referred to as an initialization pose or alternately as a master pose;

positioning the motion capture subject 148 with the right edge of the right foot in contact with the lower right front ball 136 on the scale frame 102, the upper right front ball 132 visible in the camera image, and the front of the subjects torso, hands, and legs as close to the plane of the front side of the scale frame as possible;

converting the image of the motion capture subject to a silhouette 150 with at least three balls 106 on the scale frame 102 distinguishable from the subject's image;

overlaying an actor file, optionally an actor file compatible with a format such as Biovision Hierarchical Data (BVH), on the silhouette;

optimizing the positioning of biomechanical reference locations on the silhouette 150;

rotating the motion capture subject 148 within the scale frame 102 by ninety degrees about the z-axis so the subject's side is pointed at the optical axis of the camera lens, for example the subject's right side as suggested in FIGS. 3; and

repeating the step of optimizing the positioning of biomechanical reference locations;

wherein the step of optimizing further comprises any one or more of the following steps, singly or in combination:

flapping hands around an axis parallel to the optical axis of the camera lens;

flapping upper arms the axis parallel to the optical axis of the camera lens;

raising arms to a horizontal position, also referred to as a “T=pose”, and raising shoulder tips (clavioscapular) along the axis parallel to the optical axis of the camera lens while keeping arms parallel to the ground;

relaxing (dropping) shoulder tips;

returning to the T-pose without using clavicles and then rotating only the elbows around an axis parallel to the optical axis of the camera lens;

returning to the initialization pose;

rotating the head and neck about a horizontal axis perpendicular to the optical axis of the camera lens;

rotating the rib cage about a horizontal axis perpendicular to the optical axis of the camera lens;

moving the torso from the waist up in rotation about a horizontal axis perpendicular to the optical axis of the camera lens;

putting weight on the right foot, slipping the left foot out from under the strut at the front of the scale frame by bending the left knee and straightening the left knee after the left foot has passed behind the lower front left ball;

raising and lowering the left upper thigh in rotation about a horizontal axis perpendicular to the optical axis of the camera lens;

raising the left foot slightly higher than the lower front left ball and rotating the ankle;

putting weight on the left foot, slipping the right foot out from under the strut at the front of the scale frame by bending the right knee and straightening the right knee after the right foot has passed behind the upper front right ball;

raising and lowering the right upper thigh in rotation about a horizontal axis perpendicular to the optical axis of the camera lens;

raising the right foot slightly higher than the lower front right ball and rotating the ankle;

raising the right upper arm with relaxed clavicle joint, stiff elbow, and stiff wrist while keeping the arm parallel to the ground and thumbs pointed up, then rotate\ing the wrist about an axis parallel to the optical axis of the camera lens;

raising the clavicle so the scapula rotates around the a horizontal axis perpendicular to the optical axis of the camera lens;

keeping arms parallel to ground and pointing forward, pushing the clavicles forward and back, corresponding to rotation about the z axis;

slouching forward to rotate the ribcage around a horizontal axis perpendicular to the optical axis of the camera lens;

rotating the head and neck forward and back around a horizontal axis perpendicular to the optical axis of the camera lens;

bending from the waist forward around a horizontal axis perpendicular to the optical axis of the camera lens;

putting weight on the left foot, moving the right foot from under front lower strut and raising the right leg from behind, raising the leg as far as possible without moving other limbs, around the right upper leg's pelvis joint;

activating a warning to the subject when unwanted motions in model segments are detected;

measuring the radius of motion of distal segments;

without bumping the scale frame, raising the right leg without bending the knee joint, toes pointed up, preferably moving the leg in rotation about an axis parallel to the optical axis of the camera lens, and preferably keeping the torso and hips stationary;

with elbows locked, swinging both arms in rotation about a horizontal axis perpendicular to the optical axis of the camera lens;

raising the right knee so the thigh is parallel to the ground and motionless, then rotating the lower leg around a horizontal axis perpendicular to the optical axis of the camera lens;

subtracting the radius of motion for the lower leg from the radius of motion for the entire leg; and

keeping the thigh parallel to the ground with the lower leg dangling down, rotating the ankle joint around a horizontal axis perpendicular to the optical axis of the camera lens.

Unless expressly stated otherwise herein, ordinary terms have their corresponding ordinary meanings within the respective contexts of their presentations, and ordinary terms of art have their corresponding regular meanings.

What is claimed is:

1. An apparatus, comprising:
a digital camera;
a central processing unit in data communication with said digital camera;
a memory in data communication with said central processing unit; and
an image calibration tool comprising:
a first calibration marker, a second calibration marker, and a third calibration marker;
a first strut connected between said first calibration marker and said second calibration marker; and
a second strut connected between said first calibration marker and said third calibration marker with a first straight line segment between said first calibration marker and said second calibration marker perpendicular to a second straight line segment between said first calibration marker and said third calibration marker,
wherein said central processing unit is adapted to scale an image recorded by said digital camera in said memory by comparing a distance measured between said first and second calibration markers to a corresponding distance in the image between said first and second calibration markers.

2. The apparatus of claim 1, wherein said image calibration tool comprises eight calibration markers with each of said eight calibration markers positioned at a separate vertex of a cube.

3. The apparatus of claim 2, further comprising an additional plurality of struts with each of said plurality of struts connecting a pair of calibration markers adjacent to one another along an edge of said cube.

4. The apparatus of claim 1, wherein said apparatus includes exactly one digital camera.

5. The apparatus of claim 1, wherein said first calibration marker is formed as a sphere.

6. The apparatus of claim 1, wherein said second calibration marker is formed as a cube.

7. The apparatus of claim 1, wherein said first calibration marker is located at an intermediate position along a length of said first strut.

8. The apparatus of claim 1, wherein said first strut is curved.

9. The apparatus of claim 1, wherein said image calibration tool further comprises fourth calibration marker and a third strut connected between said first calibration marker and said fourth calibration marker with a third line segment between said first calibration marker and said fourth calibration marker perpendicular to said first line segment and to said second line segment.

10. The apparatus of claim 1, wherein said image calibration tool comprises at least two adjoining mutually perpendicular solid faces.

11. The apparatus of claim 1, wherein said digital camera, said central processing unit, and said memory are provided in a portable electronic device having a flat panel display.

12. The apparatus of claim 1, wherein said image calibration tool is attached to a headband.

13. The apparatus of claim 1, wherein said image calibration tool is adapted to surround both feet of a motion capture subject.

14. The apparatus of claim 11, wherein said portable electronic device further includes a touch input system coupled to said flat panel display.

15. A method for motion capture from digital camera images, comprising:
capturing a sequence of digital images of a motion capture subject, at least one of said sequence of digital images including an image of an image calibration tool;
determining a separate scale factor for each of at least two mutually orthogonal spatial directions by comparing a separation distance between two calibration markers on the image calibration tool to a corresponding distance between the same two calibration markers in each of said sequence of digital images;
overlaying a biomechanical skeleton over each of the sequence of digital images with a biomechanical reference location superimposed over a movable joint of the motion capture subject and at least one link rotatably coupled to the biomechanical reference location, wherein a length of the link in each image corresponds to a projected length;
determining a true length for each link by adjusting the projected length by the scale factors for each of the at least two mutually orthogonal spatial directions; and
positioning a joint in the biomechanical skeleton at the biomechanical reference location and coupling a link having a true length to the joint.

16. The method of claim 15, further comprising converting each of the sequence of digital images to a corresponding silhouette, then overlaying the biomechanical skeleton over each silhouette.

17. The method of claim 15, further comprising:
recording a front view image of the motion capture subject;
recording a side view image of the motion capture subject;
determining an accurate spatial location for the biomechanical reference location from a comparison of a projected distance in the front view image with a corresponding projected distance in the side view image.

18. The method of claim 15, further comprising:
rotating a part of the motion capture subject's body about an axis parallel to an optical axis of the camera lens;
positioning the biomechanical reference location at a center of rotation for the rotated part of the motion capture subject's body; and
positioning a joint in the biomechanical skeleton at the biomechanical reference location.

19. The method of claim 15, further comprising positioning the image calibration tool in contact with the motion capture subject.

20. The method of claim 15, further comprising positioning the motion capture subject with a foot inside the image calibration tool.
